(19) United States
(12) Patent Application Publication
(10) Pub. No.: US 2017/0287096 A1
(43) Pub. Date: Oct. 5, 2017

(54) COLLATERAL DELIVERY UNITS, SYSTEMS AND METHODS FOR DELIVERING COLLATERAL CONTENT

(71) Applicants: John M. Lyons, Long Beach, CA (US); Michael J. Lyons, Long Beach, CA (US); Patrick M. Lyons, Laguna Beach, CA (US); Brian J. Weinstein, Lincolnshire, IL (US)

(72) Inventors: John M. Lyons, Long Beach, CA (US); Michael J. Lyons, Long Beach, CA (US); Patrick M. Lyons, Laguna Beach, CA (US); Brian J. Weinstein, Lincolnshire, IL (US)

(73) Assignee: Innovation720, LLC, Long Beach, CA (US)

(21) Appl. No.: 15/512,502

(22) PCT Filed: Sep. 18, 2015
(86) PCT No.: PCT/US15/51018

§ 371 Date: Mar. 17, 2017

Related U.S. Application Data
(60) Provisional application No. 62/052,898, filed on Sep. 19, 2014.

(51) Int. Cl. G06Q 90/00; B65D 33/00; B65D 33/04

(52) U.S. Cl. CPC G06Q 90/00; B65D 33/04; B65D 33/004; G06K 19/06037

(57) ABSTRACT

Embodiments of the present invention include collateral delivery units, systems and methods of use thereof. The collateral delivery units and systems described herein can be used to distribute collateral materials—from product samples to game pieces and interactive content. The collateral delivery units and systems may also be used to distribute information about publicly available resources to those in need thereof. Various embodiments of the collateral delivery units, systems and methods described herein allow a vendor to expand and extend a consumer's retail shopping experience through integrating marketing content onto a shopping bag.

### CROSS REFERENCE TO RELATED APPLICATIONS

This application claims priority under 35 U.S.C. §119(e) from U.S. Provisional Application No. 62/052,898, filed on Sep. 19, 2014, which is hereby incorporated herein by reference in its entirety.

### FIELD OF THE INVENTION

The present invention generally relates to devices, systems and methods for delivering collateral content.

### BACKGROUND

The following description includes information that may be useful in understanding the present invention. It is not an admission that any of the information provided herein is prior art or relevant to the presently claimed invention.

Retailers and brand partners are constantly looking for new ways to reach and engage customers during their shopping experience. However, there are limited opportunities that are operationally viable on a mass market basis to enrich and extend that experience. There is a need in the art for innovative articles of manufacture, systems and methods for improving the customer experience, before, during and after the sales process.

### SUMMARY OF THE INVENTION

In various embodiments, the invention teaches a collateral delivery unit that includes one or more pouches including one or more sections, wherein one or more of the pouches are configured to hold collateral material, and wherein the collateral delivery unit is configured to be secured to a bag. In some embodiments, one or more sections of the one or more pouches are partially or completely translucent, thereby forming one or more windows. In some embodiments, one or more of the translucent sections are made of a material that includes plastic. In some embodiments, one or more of the non-plastic sections of the one or more pouches includes paper. In some embodiments, the collateral delivery unit further includes one or more sections imprinted with content. In certain embodiments, the collateral delivery unit includes one or more sections imprinted with content selected from the group consisting of a QR code, a bar code, an alpha-numeric code, instructions, a promotional offer, branding, advertising, and combinations thereof. In some embodiments, the collateral delivery unit includes two adjacent windowed pouches connected by a perforated seam.

In certain embodiments, the invention teaches a system that includes a collateral delivery unit described above attached to a bag. In certain embodiments, the bag is a retail shopping bag. In some embodiments, one or more pouches of said collateral delivery unit contain one or more collateral materials, which are thus integrated into the system. In certain embodiments, the collateral material includes an informational pamphlet describing one or more publicly available resources. In certain embodiments, one or more of the publicly available resources are health-related resources. In some embodiments, one or more of the collateral materials is a sample of a product.

In various embodiments, the invention teaches a method for delivering one or more collateral materials to a person. In some embodiments, the method includes providing a system described above to a person in need of one or more publicly available resources. In some embodiments, one or more of the publicly available resources is a health-related resource.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1A depicts, in accordance with an embodiment of the invention, a front view (outside) of a collateral delivery unit 100.

FIG. 1B depicts, in accordance with an embodiment of the invention, a back view (inside) of the collateral delivery unit 100.

FIG. 1C depicts, in accordance with an embodiment of the invention, a front view of the sealed collateral delivery unit 100. Samples A and B are enclosed in the collateral delivery unit 100, and viewable through plastic windows 103 and 107, respectively.

FIG. 1D depicts, in accordance with an embodiment of the invention, a back view of the sealed collateral delivery unit 100, with adhesive tape 111a and 111b for affixing the collateral delivery unit 100 to a bag.

FIG. 2 depicts, in accordance with an embodiment of the invention, a collateral delivery system 300, which includes a shopping bag 200 (with a handle 201) and a sealed collateral delivery unit 100 (containing samples A and B) affixed thereto.

### DETAILED DESCRIPTION OF THE INVENTION

All references cited herein are incorporated by reference in their entirety as though fully set forth. Unless defined otherwise, technical terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials specifically described.

In some embodiments, properties such as dimensions, shapes, relative positions, and so forth, used to describe and claim certain embodiments of the invention are to be understood as being modified by the term “about.”

The terms “customer” and “consumer” are used interchangeably,

The term “bag,” as used herein, refers to any bag of any size, shape, and material, capable of holding objects. Merely by way of non-limiting examples, the bags referenced herein can be made of one or more materials including paper, plastic, nylon, Tyvek, 1,5 composite materials, recycled materials, clothe and the like. In some embodiments, the bag has handles to facilitate transport of the bag and goods it contains, while in other embodiments the bag does not have handles. In some embodiments, the bag is a retail shopping bag.

The terms “collateral” and “collateral material,” as used herein, refer to any marketing, promotional, or educational material. Merely by way of non-limiting examples, collateral materials can include product samples, game pieces, educational materials, printed promotional offers, coupons, instructions, audio media (e.g. compact discs), video media (e.g. digital video discs), memory devices (compatible with USB drives or otherwise), digital chips, digital displays, RFID, NEC, chips, contest pieces, surveys and the like.

By way of additional background, most consumers rely on shopping bags to transport goods purchased from a retail location. Importantly, those consumers often retain the bags in their homes or places of work for an extended period of time, long after their retail shopping experience has been completed. While some consumers reuse shopping bags to transport additional items, others use them as waste receptacles, or save them for bulk recycling or other purposes.

Many retail establishments already incorporate branding in their shopping bags, in the form of logos, slogans, designs and the like. However, considering the utility of shopping bags, and the average length of time consumers interact with them, the opportunity to design and use shopping bags as effective marketing media, and thereby extend customers' retail shopping experience, has been largely overlooked.

In order to expand upon the opportunities for marketing to and/or educating consumers, the inventors have developed collateral delivery units. Each embodiment of the collateral delivery units described herein is designed to be attached to a bag, thereby forming a system for delivering collateral. Thus, in each instance in which a collateral delivery unit is described, both the collateral delivery unit and the system (collateral delivery unit attached to a bag of any kind) are contemplated as being within the scope of the invention. Furthermore, in addition to the collateral delivery units and systems described herein, embodiments of the invention also include the method of (1) loading the collateral delivery units described herein with collateral materials; (2) loading the bag component of the systems described herein with goods; and (3) loading the collateral delivery units of the systems described herein with collateral material. In certain embodiments, the invention also includes the methods of (1) removing collateral material from the collateral delivery units described herein; (2) removing goods from the bag components of the systems described herein; and (3) removing collateral materials from the collateral delivery component of the systems described herein.

In various embodiments, the invention also teaches using the inventive collateral delivery units and systems described herein as a vehicle for delivering informational material to the public. In some embodiments, the informational material includes a single paper or collections of papers (i.e. pamphlets or booklets) that describe publicly or privately available resources. Merely by way of nonlimiting example, public resources may include public health programs. Non-limiting examples of such public health programs may include government sponsored education programs, prenatal care, neonatal care, child care, nutrition assistance, food programs, parenting programs, vaccination schedules, health warnings regarding certain products or concerning disease outbreaks (at the local, city, state, or federal level), domestic abuse resources, alcohol abuse resources, drug abuse resources, and the like. In some embodiments, one or more of the pouches of the collateral delivery units includes a pamphlet that describes a publicly available resource, and the same or a different pouch of the collateral delivery unit includes a related sample. For example, a pouch may include a toothbrush and/or toothpaste, and the same or a different pouch may include information about dental care that is provided at a low cost or no cost to the public. In another example, a pouch may contain a quantity of prenatal vitamins and the same or a different pouch may include information about free or low cost prenatal care.

Non-limiting examples of privately available resources include private medical services, dental services, prenatal services, neonatal services, and the like. The private services may be offered at a discount to certain customers, or may be offered at full price.

Numerous examples of collateral delivery units, systems, and methods for adding collateral to collateral delivery units and shopping bag systems are included herein below, but these examples are in no way intended to be limiting.

### Collateral Delivery Units

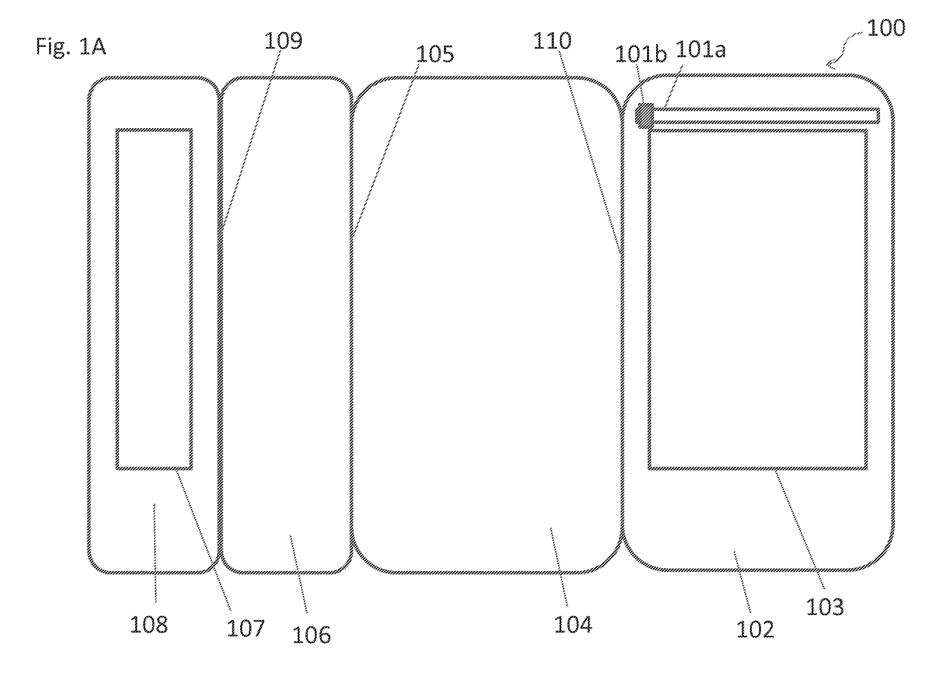

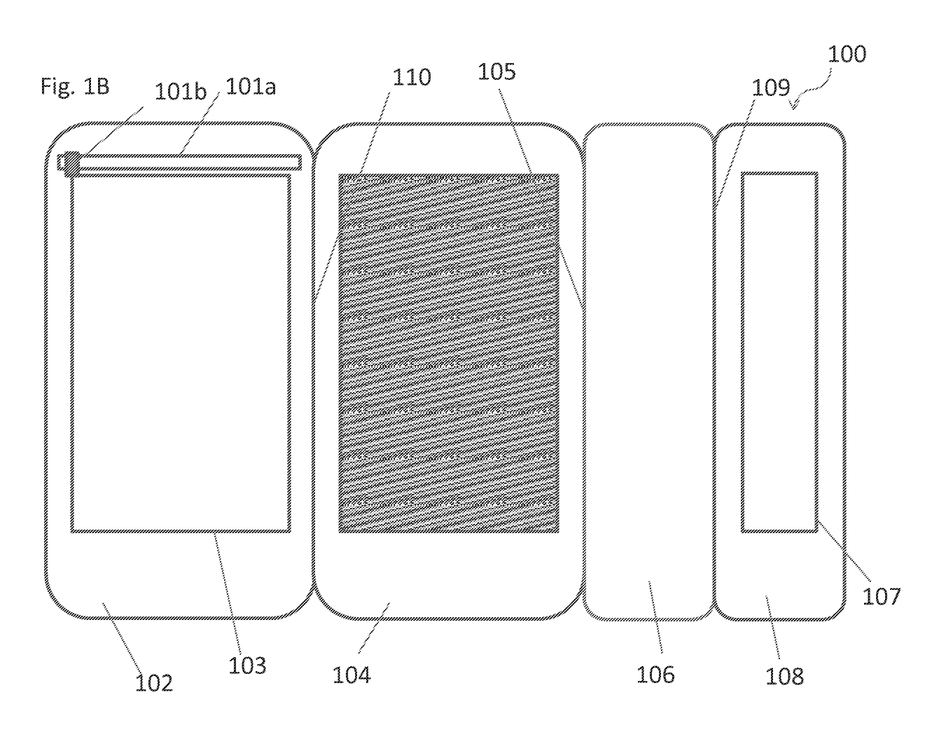

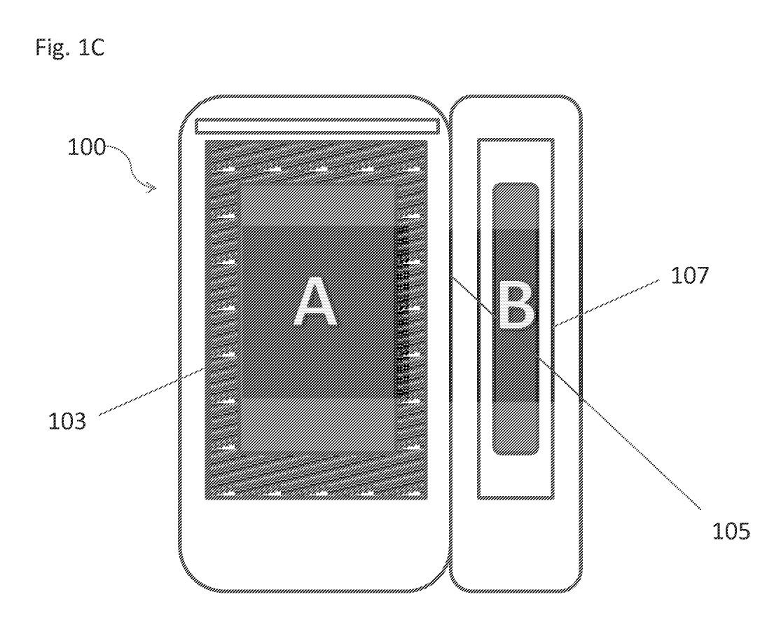

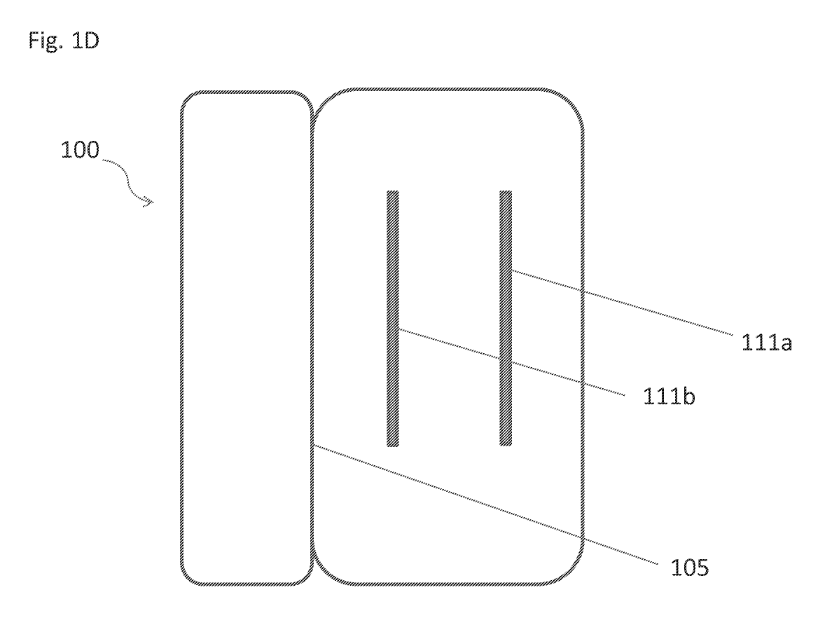

In some embodiments, the collateral delivery unit of the invention includes one or more pouches. Each pouch can be of any size and shape appropriate to deliver the desired collateral material to a consumer (e.g. circular, oblong, rectangular, heart-shaped, etc.). In some embodiments, the pouch is formed by gluing, taping, or otherwise affixing some or all of the borders on the faces of two or more contiguous or separate sections of material. In some embodiments, a single contiguous piece of material is folded along one or more axis (e.g. along one or more seam) to form a pouch. Merely by way of example, folding along seams 109 and 110 shown in FIGS. 1A and 1B results in the folded collateral delivery unit shown in FIGS. 1C and 1D. In some embodiments, collateral materials can be sealed inside one or more pouches of the collateral delivery unit, and later accessed by a consumer. For example, FIG. 1C, shows samples A and B which were loaded onto panels 104 and 106 (see FIGS. 1A and 1B), respectively, prior to folding along seams 109 and 110 (see FIGS. 1A and 1B). Adhesive placed on the borders of panels 104 and 106 allows for forming adjacent pouches upon folding along seams 109 and 110, as the adhesive binds the boarders of panel 104 with panel 102, and panel 108 with panel 106.

In certain embodiments, the pouches described herein are re-sealable, while in other embodiments the pouches can only be opened and/or closed once.

In certain embodiments, all or part of at least one face of the pouch is partly or completely translucent, thereby forming a “window.” Merely by way of non-limiting example, one or more windows of the pouch can be made of a relatively thin and translucent plastic material, such that the content inside of the pouch can be viewed (as demonstrated in FIG. 1C), or partially viewed (for instance if the window in FIG. 1C, were a smaller size), without opening the pouch. In certain embodiments, one or more of the windows is 10% of the square area of one or both faces of the pouch. In other embodiments, one or more of the windows is 20-100%, or 30-90% or 40-80%, or 50-70% or 60-65% of the square area of one or both faces of the pouch, in various embodiments, one or more windows of the pouch are made of a colored plastic material. In various embodiments, one or more windows or borders of the pouch are made of a material that is luminescent. In various embodiments of the invention, one or more border, window, or interior of the pouch are made or coated with a material that glows in the dark. In some embodiments, one or more entire face of the pouch is partly or completely opaque. In certain embodiments, one or more entire face of the pouch is partly or completely impermeable to ultraviolet light.

In some embodiments, one or more of the pouches may contain a window which is completely opaque (either by using a colored plastic or similar material, or by using another non-translucent material to form the pouch). A completely opaque window or pouch may be used to conceal money, one or more lottery tickets, prizes, coupons for significant discounts and the like, which may be included in the pouch. In some embodiments, the collateral delivery unit or system includes an opaque pouch along with a translucent pouch. In these embodiments, the translucent pouch may include a product sample, print, or other visual clue as to what type of prize might be contained in the opaque pouch.

In some embodiments, the invention teaches a method of affixing a collateral delivery unit described herein with an opaque pouch to a shopping bag. In some embodiments, the shopping bag to which the opaque pouch is affixed is coded (color coded, encoded with a specific print code in any form described herein, and the like) in such a way as to indicate that the collateral delivery unit(s) affixed thereto has a higher probability of having a prize with a certain value range. Thus, for instance, a manufacturer, or retailer would join a coded shopping bag with a collateral delivery unit having an opaque pouch with one or more prizes within a specific value range. In this way, a vendor may load a customer's purchase(s) into a bag with a collateral unit affixed thereto that contains (or has a certain likelihood of containing) a prize or prizes within a specific value range. Thus, a customer who spends more may receive a bag with a collateral delivery unit that contains (or has a higher likely hood of containing) a prize or prizes with a greater value than a customer who spends less would receive. Numerous tiers of bags and collateral delivery units may be appropriately coded to achieve this type of promotion. In some instances, the type of bag (and therefore collateral delivery unit and prize) given to the customer depends upon tracked aggregate spending over a certain period of time (tracked through a conventional rewards program, by identifying information of the customer (e.g. name or phone number), or otherwise), rather than on a per-purchase basis.

The collateral delivery units can be made of any of a number of suitable materials for holding collateral, including, but in no way limited to, paper, plastic, Tyvek, nylon, cloth, composite materials, recycled materials, combinations thereof and the like. In some embodiments, the panels of the collateral delivery unit (e.g. elements 102, 104, 106 and 108 in FIGS. 1A and 1B) are made of paper, while the windows (e.g. elements 103 and 107 in FIGS. 1A and 1B) are made of plastic.

Various thicknesses of one or more of the aforementioned materials can be used to form the pouch (including the window), depending upon the desired strength and flexibility of the pouch, and the nature of the bag to which it is intended to be affixed, as well as the nature of the content that is to be included in the pouch. For instance, thicker plastic or paper (such as cardboard) may be used to form the aforementioned windows or borders of the pouch, respectively, if the collateral material it is intended to hold is heavier and/or sharper; whereas thinner plastic or paper may be used to form the aforementioned windows or borders of the pouch, respectively, if lighter and/or more blunt collateral material is intended to be included in the pouch and/or the pouch is intended to be affixed to a very flexible bag (e.g. a plastic bag),

In some embodiments, at least one portion of the interior of the pouch includes print. In some embodiments, the print is in the form of one or more game pieces, one or more codes (QR codes, bar codes, alpha-numeric codes, etc.—as described herein), one or more coupons, and the like.

In some embodiments, one or more portion of the pouch is perforated and/or otherwise attenuated (e.g. with a thinner section of material) such that the pouch can be easily opened. In some embodiments, the portion of the pouch that is perforated also includes a tab, such that when the tab is pulled, the perforated portion of the pouch is opened, and the contents of the pouch (e.g. collateral material) can be accessed. Merely by way of non-limiting example, the perforated portion of the pouch can be in the shape of an elongated rectangle (as demonstrated by element 101a of FIG. 1A;), and a pull tab (as demonstrated by element 101b of FIG. 1A) is connected thereto. In certain embodiments the attenuated (e.g. perforated paper, plastic, etc.) section of the pouch extends along all or part of the length or width of a face of the pouch (e.g. element 101a of FIG. 1A). In some embodiments, the attenuated section of the pouch extends along all or part of the length of an edge of the pouch.

Advantageously, the collateral delivery unit can include two or more pouches. The two or more pouches can be of the same size and shape, or they can be different sizes and shapes to accommodate the different sizes, shapes and weights of collateral material they are designed to hold. Merely by way of example, FIG. 1C demonstrates collateral delivery unit 100 that includes pouches positioned side-by-side holding samples A and B, respectively.

The two or more pouches can be joined in a number of different ways, including, but in no way limited to, along all or a portion of one or more edge, along all or a portion of one or more faces, and combinations thereof. Merely by way of example, FIG. 1C demonstrates collateral delivery unit 100 that includes perforated seam 105 that runs along the entire length of the interface of the pouches holding samples A and B.

In some embodiments, multiple pouches are joined to one another through an intervening section of material. The intervening section of material can intervene between any of the aforementioned edges, borders, or faces, and it can be made of the same material as one or more of the aforementioned edges, borders, or faces; or it can be made of a different material than one or more of the aforementioned edges, borders, or faces.

In some embodiments in which the collateral delivery unit includes multiple pouches, one or more of the pouches are configured with appropriate dimensions (height, width and depth) to include one more forms of written content (e.g. paper or other printed material in the form of coupons, promotions, special offers, and the like), while another pouch is configured with appropriate dimensions to contain one or more forms of non-printed content/collateral (e.g. a sample of a product). In some embodiments, one or more border or other section of the collateral delivery unit itself includes print (i.e. one or more types of print described or mentioned above is imprinted on the collateral delivery unit). In some embodiments, the collateral delivery unit is affixed to a bag that includes print (i.e. one or more types of print described or mentioned above is imprinted on the bag to which the collateral delivery unit is affixed).

One or more sections of the collateral delivery units described herein (e.g. one or more of the backs (non-window containing sides) of the pouches, borders, etc.) can be configured to be affixed to a shopping bag in any of numerous ways for affixing objects to one another known in the art. For instance, one or more of any of the sections of a collateral delivery unit described herein can include adhesive appropriate to attach the collateral delivery unit to a shopping bag. Any appropriate adhesive is intended to be within the scope of the invention. Merely by way of non-limiting examples, the adhesive can be reactive or non-reactive. The adhesive may be any type of glue that is known to bond the material of the collateral delivery unit to the material of the bag. The adhesive may be of a type that hardens while drying (e.g. solvent based adhesive or polymer dispersion adhesive). Additionally, or alternatively, tape can be used as an adhesive (e.g. two-sided tape). In one embodiment, a face of a single pouch of the collateral delivery unit has adhesive applied to the non-window containing face, while one or more additional pouches of the collateral delivery unit do not contain adhesive on the non-window containing face. For example, FIG. 1D demonstrates an embodiment of the invention in which the larger of two pouches includes adhesive on its non-windowed face, while the smaller of two pouches does not include adhesive on its non-windowed face.

### Collateral Delivery Systems

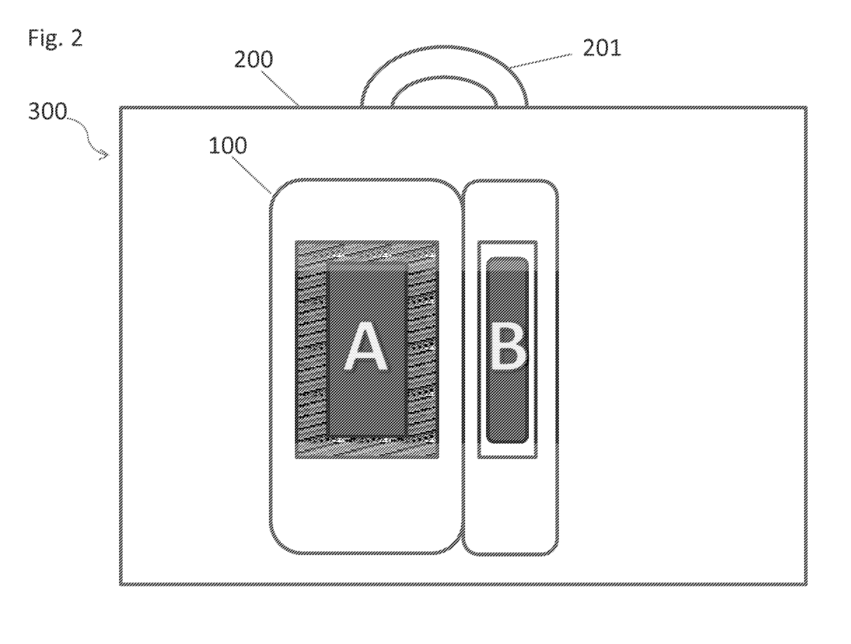

While certain non-limiting examples provided herein describe collateral delivery units with one or more pouches that can be affixed to a bag, other embodiments of the invention include a system that includes any bag described herein with any collateral delivery unit described herein affixed thereto. Merely by way of example, FIG. 2 demonstrates collateral delivery unit 100 affixed to bag 200, thereby forming collateral delivery system 300. Although the collateral delivery unit can be fitted with an adhesive to attach to a bag, as described above, the bag itself can also, or alternatively, include a section bearing any type of adhesive described herein above, which can be used to secure the bag to the collateral delivery unit.

### Printed Collateral/Content

In some embodiments, the invention teaches a collateral delivery unit configured for delivering printed content. The printed content can be provided directly onto a section of the collateral delivery unit (i.e. imprinted thereon), or it can be printed onto a medium that is included in one or more of the pouches of the collateral delivery unit (as described above) In some embodiments, the printed content is in the form of display advertising, promotional offers, discount coupons, games, educational material, instructions, codes for accessing free or discounted media through the interact, surveys, contests, and the like. In some embodiments, the printed content is conveyed and accessed through the use of barcodes, QR codes, augmented reality triggers, text, mobile, web addresses, phone numbers, or any type of code that can be read by an electronic device (e.g. a cell phone, tablet, or other “smart device”). Merely by way of example, the code can be read by using an application running natively on the electronic device. In some embodiments, one or more codes are used to direct the electronic device to web-content, which may include, but is in no way limited to mobile, social, gamification, gaming (any content related to games) and other digital content. In other embodiments a native application finning on the electronic device is used to directly access and/or generate the content via interacting with a printed code. In some embodiments, the codes (bar codes, QR codes, etc.) are designed to access augmented reality content and/or other digital content when viewed by using an electronic device (e.g. a cell phone, tablet, or other smart device). The content may include entertainment, music, gaming, portal links and digital links. In this context, printed material (including imprinted material) on or in the collateral delivery unit and/or bag to which it is attached can be used to access (digitally through an electronic device or directly) contests, savings, music, movies, portals to other technologies, and the like.

Augmented reality (AR) features can expand the content offering and can function as an activated content experience, launching content in various forms (including but not limited to any type of content described herein) on the consumers' electronic devices. As consumers point their devices at the programed AR triggers, content will be launched on those devices for consumer enjoyment and/or interaction and/or education. The AR triggers located on or in (by way of print on a paper medium etc.) the collateral delivery unit or bag will build in other retail off-bag experiences tied to the originating bag program.

A non-limiting example of this type of experience is a treasure hunt promotion that is initiated from the bag, in which off hag treasures and/or clues and/or games extend to other areas of the retail environment, POS, and other promotional markers, which may be displayed in, on, or around items in the retail environment, including but not limited to on items for sale (in printed format or otherwise). In some embodiments, one or more of the codes, game elements, or other printed content is printed on the interior of one or more of the pouches described herein, such that they can be obscured from view by samples, coupons, or other physical articles, until the pouch is opened by the consumer. By using this approach, access to said codes or content is limited to paying consumers who have received the collateral delivery unit as a result of purchasing goods or services.

In some embodiments, the collateral delivery unit includes a pair of glasses (disposable or reusable) with lenses of plastic or other material that allows for viewing light of a selective wavelength that is not viewable (or not as easily viewed) by the human eye without the aid of the glasses. The glasses can then be used to view printed messages or other content on retail items on or around a store or other retail environment. These messages may include, but are in no way limited to information about discounts, educational or entertaining messages for children, and information about clues to contests. By placing clues around a store or other retail environment in strategic locations, for example in specific locations in specific aisles of a grocery store, a customer (or a child or other companion wearing the glasses) may be encouraged to view certain items that a vendor wishes to sell or promote.

In accordance with the educational examples and entertainment examples above, the AR features can be used to launch content on a consumer's electronic device which may be educational in nature, and which could be used to provide information about any publicly or privately available resource, including but not limited to any of those described herein.

### Non-Printed Collateral/Content

In addition to the aforementioned examples of printed material, non-printed material can also be incorporated into the collateral delivery units and systems described herein. By way of non-limiting examples, this material can take the form of product samples, game elements (e.g. game pieces and/or a game board), contest elements, awards, electronic media (e.g. compact discs, digital video discs, flash drives, gaming, software, virtual awards, loyalty programs, points, credits, consumer publishing software, consumer sharing software, etc.) and the like.

Advantageously, the collateral delivery units and systems described above can be used to enable the controlled delivery of promotional and advertising materials to consumers through a pre-manufactured bag system with pouches enclosing promotional and/or advertising materials (or any other type of collateral described or referenced herein) intended to increase value while not posing any operational hurdles for the distribution of the bags at the point-of-sale. The aforementioned advancements in design and pouch-based structure enable automated manufacturing, assembly and easily controlled and secured distribution of bags, promotional materials, samples and display advertising all in one product.

The ensuing examples are intended to be illustrative only, and they are in no way intended to be limiting.

### EXAMPLES

### Example 1

### Collateral Delivery Unit

FIG. 1A depicts a front (outside) view of exemplary collateral delivery unit 100. Collateral delivery unit 100 includes perforated box section 101a with pull tab 101b; plastic window 103 in first elongated panel 102, second elongated panel 104; first joining segment/seam 110 (joining elongated panels 102 and 104); third elongated panel 106; plastic window 107 in fourth elongated panel 108; second joining and perforated segment 105 (joining panels 104 and 106); and third joining segment/seam 109 (joining panels 106 and 108). FIG. 1B depicts a back view (inside) of exemplary collateral delivery unit 100.

FIG. 1C depicts a front view of exemplary collateral delivery unit 100 in which (a) collateral samples A and B have been loaded onto panels 104 and 106, respectively (See FIGS. 1A and 1B); (b) panel 102 has been positioned on top of panel 104 by folding along first joining segment/seam 110 (See FIGS. 1A and 1B); (c) panel 108 has been positioned on top of panel 106 by folding along third joining segment/seam 109. Adhesive (not shown) has been placed on the sections of panel 106 which contact panel 108 (after panel 108 has been folded onto panel 106 along third joining segment/seam 109). Likewise, adhesive (not shown) has been placed on the sections of panel 104 which contact panel 102 (after panel 102 has been folded onto panel 104 along first joining segment/seam 110). Thus, sealed pouches containing samples A and B are formed (See FIG. 1C).

FIG. 1D shows that the non-windowed face of the larger pouch (formed by panels 102 and 104) includes adhesive strips 111a and 111b, so that collateral delivery unit 100 can be affixed to a bag.

### Example 2

### Collateral Delivery System

FIG. 2 depicts collateral delivery system 300, which includes collateral delivery unit 100 affixed to shopping bag 200 (with handle 201). Collateral delivery unit 100 includes samples A and B, which can be viewed through the plastic windows of the pouches that contain them.

### Example 3

### Integrated Collateral Delivery Units

One or more built in pouches are added on the front and/or back of a bag (paper or plastic). 1-2 or more window (plastic as described herein or otherwise optionally translucent or opaque material) openings are added and create 1-2 or more separate pouch compartments. The window sizes can be different if desired, and can be made to line up horizontally, or placed in any orientation on the bag. When two or more windows are used, they can have any desired amount of spacing between them. In some cases, a 1″ spacing between the windows may be especially desirable for use in some retail environments. For paper bags, the window opening may be any appropriate distance from a score or fold used to form the paper bag from a single sheet of material. In some instances a window opening can be at least 1-½″ away from any score or fold for greater structural integrity of the bag as a whole.

When paper bags are used in conjunction with the examples directly above, they may be printed on flat sheet fed or web printing presses. The bags are then die cut. The window openings are also die cut. The die cut flat pieces are then placed into a bag converting machine. Glue is then patterned around the die cut window and a clear window film (e.g. plastic) is applied. Next the product sample, booklet or other article is fed on top of the window and then sealed in by folding and gluing panel flaps. Optionally, a slit can be die cut into the bag just above the window thus allowing access to the product. For ease of manufacturing a belt section can be added to the machine between an initial feeder and the first fold section. The belt section can have a pattern glue unit, window patch unit and one or more product feeders. With this configuration, a machine could produce 3000 or more bags per hour.

### Example 4

### Direct Application of a Window to Bag

A sample, booklet or other object can be fed onto a paper or plastic bag and a clear (or opaque or colored or other type described herein) window film can be applied over it. If a roughly rectangular shaped window film is used, adhesive strips can be included between the window film and bag on 3-4 sides (near the edges) of the window film. In the event that adhesive is included on 3 sides, a top is left open to form a pouch through which the sample, book, or other object can be accessed. If all four sides of the window include adhesive, then the sample, booklet, or other object is completely sealed to the bag. One of skill in the art would readily appreciate that if a non-square shape (e.g. cone or other shape) is used, then adhesive could be appropriately applied to allow access to the sample, booklet, or other object from the top, or the adhesive could be applied in a manner that would not permit access to the object placed between the window and bag without breaking the window or disrupting one or more of the seals.

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein, including the best mode known to the inventors for carrying out the application. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A collateral delivery unit comprising one or more pouches comprising one or more sections, wherein one or more of the pouches are configured to hold collateral material, and wherein the collateral delivery unit is configured to be secured to a bag.

2. The collateral delivery unit of claim 1, wherein one or more sections of the one or more pouches are partially or completely translucent, thereby forming one or more windows.

3. The collateral delivery unit of claim 2, wherein one or more of the translucent sections are comprised of plastic.

4. The collateral delivery unit of claim 3, wherein one or more of the non-plastic sections of the one or more pouches are comprised of paper.

5. The collateral delivery unit of any of claims 1, further comprising one or more sections imprinted with content.

6. The collateral delivery unit of any of claim 4, wherein the collateral delivery unit comprises one or more sections imprinted with content selected from the group consisting of a QR code, a bar code, an alpha-numeric code, instructions, a promotional offer, branding, advertising, and combinations thereof.

7. The collateral delivery unit of claim 2, comprising two adjacent windowed pouches connected by a perforated seam.

8. A system comprising a collateral delivery unit of claim 7 attached to a bag.

9. The system of claim 8, wherein the bag is a retail shopping bag.

10. The system of claim 9, wherein one or more pouches of said collateral delivery unit contains one or more collateral materials.

11. The system of claim 10, wherein the collateral material comprises an informational pamphlet describing one or more publicly available resources.

12. The system of claim 11, wherein one or more of the publicly available resources are health-related resources.

13. The system of claim 10, wherein one or more of the collateral materials is a sample of a product.

14. A method for delivering one or more collateral materials to a person, comprising providing the system of claim 11 to a person in need of one or more publicly available resources.

15. The method of claim 14, wherein one or more of the publicly available resources is health-related.
